(19) United States
(12) Patent Application Publication
(10) Pub. No.: US 2009/0161999 A1
(43) Pub. Date: Jun. 25, 2009

(54) BEARING ARRANGEMENT FOR VENEER DRYER

(76) Inventor: Wayne Crooks, Madison, OH (US)

Correspondence Address: PEARNE & GORDON LLP, 1801 EAST 9TH STREET, SUITE 1200, CLEVELAND, OH, 44114-3108, US

(21) Appl. No.: 11/959,487

(22) Filed: Dec. 19, 2007

(51) Int. Cl. F16C 35/06

(52) U.S. Cl. 384/428

(57) ABSTRACT

A bearing mount assembly for a powered roller conveyor of the type used in veneer dryers comprising a bearing mount base and a bearing holder, the base having a lower part with a vertical surface adapted to abut a cage angle and apertures for fastening it to a vertical face of the cage angle, an upper end of the base being in the shape of a yoke open at the top for locating the shaft of an upper roller, the bearing holder having a pocket for holding an arcuate section of a sleeve bearing, the base and holder having mating surfaces capable of locating the holder in a position where it supports the bearing in registry with the desired axis of rotation of the shaft of a lower roller.

The invention relates to powered roller conveyors and, in particular, to improvements in bearing supports for conveyor rollers in board dryers.

### BACKGROUND OF THE INVENTION

Dryers used in manufacturing boards and panels such as veneer dryers employ roller conveyors to carry raw material through the dryer while it is exposed to forced hot air. In a veneer dryer, for example, the powered rollers carrying the material being dried are paired, one overlying the other so as to create a nip through which the material is conveyed. In conventional designs of veneer dryers and similar equipment, the rollers, shafts, bearings and sprockets are located in confined spaces. Sprocket driven roller shafts are ordinarily carried in carbon bearings and these bearings are in-board of the sprockets and roller chain.

The bearings, due to their operating conditions and being impractical to lubricate require relatively frequent replacement, typically as often as once a year. The labor involved in replacing the bearings in existing prior art equipment is extensive. Each of the corresponding sprockets must first be removed, the spent bearings must be forced out of their cylindrical housing bores, the replacement bearings positioned in the bores, and the sprockets remounted. This procedure is done manually one bearing at a time. Oftentimes the sprockets, which are typically keyed and closely fitted to their shafts, will be frozen on the shafts and not easily removed. A percentage of conventional sprockets, because of corrosion, can be frozen on the shafts so tightly that it is necessary to destroy them to remove them from the shafts. This frequent loss of sprockets obviously adds to the operating costs of the dryer.

### SUMMARY OF THE INVENTION

The invention provides a bearing mounting system particularly suited for a veneer dryer style conveyor that enables worn roller shaft bearings to be removed and replaced with significant savings in labor, downtime, and parts costs. The bearing mount permits the bearings to be changed without requiring drive sprockets to be removed. This feature saves the time otherwise needed to loosen, remove and later reposition and tighten the sprockets or risking destruction of the sprockets in an effort to remove them. The system, in the illustrated embodiment, utilizes a bearing segment of 180 degrees or less, thereby enabling it to be removed and installed on a roller shaft radially rather than sliding it axially over the normal operating location of the temporarily removed sprocket.

More specifically, the system includes a bearing mount assembly comprising a base and a holder. The base has a receiving zone with surfaces arranged to complement the configuration of the holder so as to allow the holder to self-align itself to the base. The bearing mount base is arranged to be bolted on a conventional cage angle and, as is conventional, has provisions for holding the shaft of the upper roller of the roller set. The base receives the holder, in which the bearing is disposed, radially from the space below the shaft. Extraneous assembly motion or gyration of the bearing holder is avoided and in an essentially intuitive manner, a technician can simply raise the bearing holder after roughly locating it under the lower roller shaft while biasing it against the mount base to properly position it in the receiving zone.

In addition to affording a much simpler and quicker manner of replacing the spent bearings than has been heretofore available, the invention can reduce the cost of the bearings themselves since the volume of bearing material is cut at least in half when practicing the invention compared to full cylinder prior art bearings. The bearing holder, besides serving the primary function of carrying the radial forces on the bearing, automatically captures the bearing with the base to angularly and axially lock it in place without separate retaining elements.

### BRIEF DESCRIPTION OF THE DRAWINGS

FIG. 1 is a fragmentary perspective view, axially exploded, of a set of rollers of a veneer dryer style roller conveyor employing the invention;

FIG. 2 is a fragmentary elevational sectional view of the conveyor looking in the conveying direction;

FIG. 3 is a fragmentary side elevational view of the conveyor taken from the chain side;

FIG. 4 is a fragmentary elevational view of the conveyor taken from the operator side;

FIG. 5 is a perspective view of a bearing holder of the invention taken from a reference point corresponding to the inside of the conveyor;

FIG. 6 is a perspective view of a bearing mount base of the invention, again taken from a reference point corresponding to the inside of the conveyor; and

FIG. 7 is an elevational view similar to FIG. 3 with the sprocket and chain removed to show constructional details of the relevant parts.

### DESCRIPTION OF THE PREFERRED EMBODIMENT

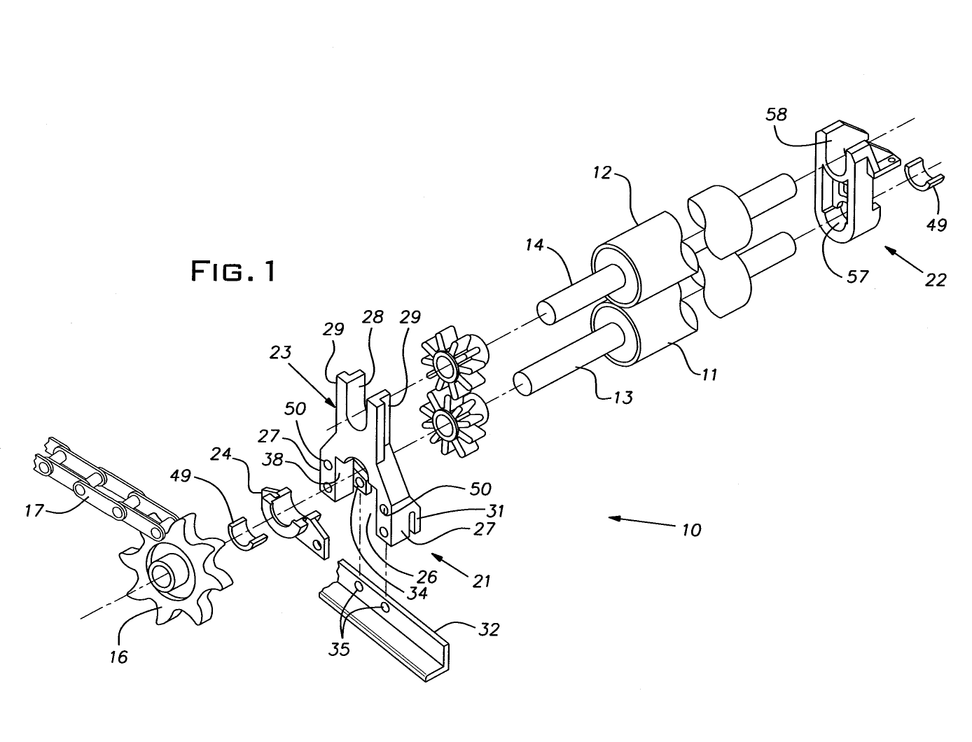

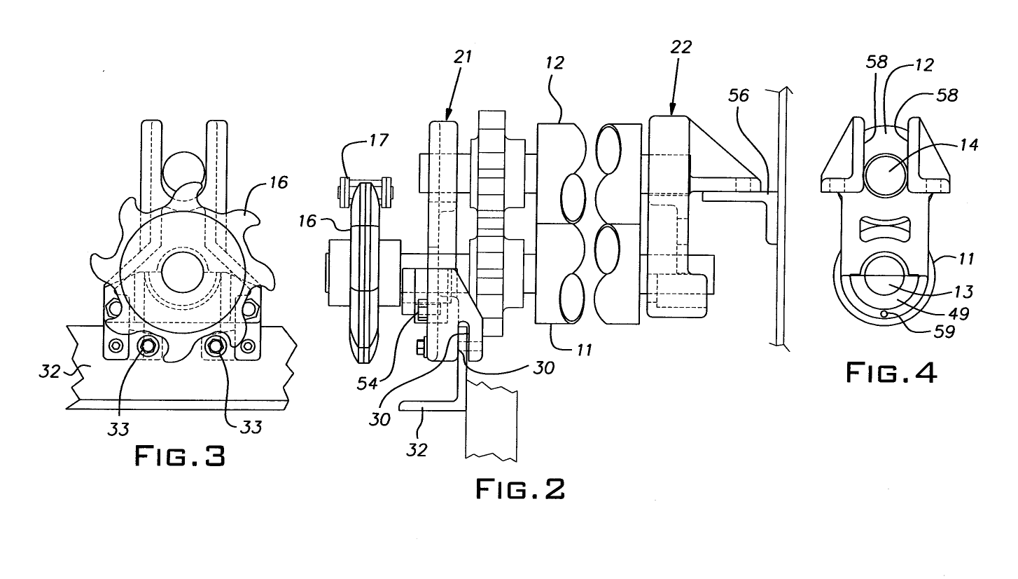

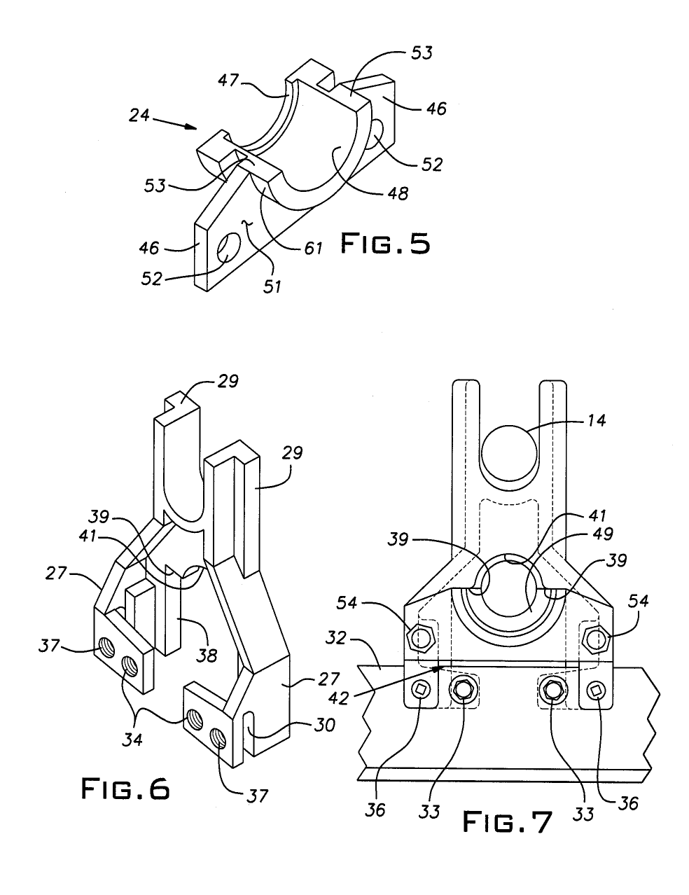

Referring now to the figures and, in particular, to FIG. 1, there is partially shown a powered roller conveyor 10 such as in a veneer dryer. The axes of pairs of rollers 11, 12 are horizontal and aligned in a common imaginary vertical plane. While only one set of rollers 11, 12 is illustrated, the conveyor 10, as is conventional, has a series of identical roller sets or pairs evenly spaced along a conveying direction in a common horizontal plane, commonly referred to as a deck. The typical dryer will have several such decks spaced one above the other. Hot air is forced through the decks to dry material being conveyed between each pair of rollers 11, 12.

The rollers 11, 12 are carried on respective shafts 13, 14 projecting from both ends of the rollers. The lower roller shaft 11 has a sprocket 16 fixed by a key and set screw on one of its ends. The sprocket 16 and like sprockets on the other rollers of the same deck are all aligned with a common imaginary vertical plane extending in the conveying direction and are all driven by a single roller chain 17.

Powered rotation of the lower roller 11 is imparted to the upper roller 12, in the opposite direction, by a pair of star gears 18 each fixed to a respective shaft 13, 14. The side of the conveyor 10 in the forefront of FIG. 1 is referred to as the chain side of the conveyor, while the far side is referred to as the operator side. The roller shafts 13, 14 are located adjacent their chain side ends by a bearing mounting unit or assembly 21 and at their operator ends by bearing mounting units 22. The chain side bearing mounting unit 21 comprises a base 23 and a bearing holder 24 removably mounted on the base. Both bearing mounting units 21, 22 are constructed of ductile iron or other suitable material and are appropriately machined.

The illustrated base 23 has an H-shaped profile when viewed in the axial direction of a roller. A lower opening 26 between lower legs 27 receives the shaft 13 and an opening 28 between upwardly extending arms 29 receives the upper shaft 14.

Lower ends of the legs 27 have aligned slots 31 sized to receive an upper edge of a frame element of the conveyor 10 referred to commonly as a cage angle 32. Vertical side surfaces 30 of the slots 31 abut vertical faces of the cage angle 32. The same cage angle 32 supports other bearing mount units or assemblies 21 on the same level or deck. The base 23 is bolted to the cage angle 32 by socket head cap screws 33 (FIG. 7) in threaded holes 34 (FIG. 6) preferably aligned with holes 35 (FIG. 1) existing in the cage angle 32. The threaded holes 34 can be arranged to align with the original cage angle holes 35 of a dryer installation enabling the bearing arrangement of the invention to be retrofitted to existing dryer conveyors. Additionally, set screws 36 (FIG. 7) are threaded into tapped holes 37 (FIG. 6) and tightened against the part of the cage angle 32 received in the slots 31 to ensure that the base 23 is firmly fixed on the cage angle.

Vertical guide surfaces 38 of the legs 27, facing each other, lie in planes parallel to the roller shafts 13, 14 and, at their upper ends terminate at horizontal stop surfaces 39. Bridging the space between the horizontal surfaces 39 is an arcuate surface 41 that is concentric with the nominal axis of the lower shaft 13 and is of a radius large enough to ensure clearance with this shaft. The vertical and horizontal surfaces 38, 39 frame a boundary of a receiving zone or pocket 42 for the bearing holder 24.

The bearing holder 24 is in the form of a hollow cylindrical segment with an integral radially extending mounting flange 46. At an end of the holder 24 remote from the flange 46, is an integral radially inwardly extending lip 47. The radius and axial length of an inside surface 48 of the holder 24 are proportioned to form a pocket that closely fits the corresponding outer dimensions of a bearing 49. The mounting flange 46 has an inwardly facing flat surface 51 which lies in a plane transverse to the axis of the cylindrical surface 48. The flange 46 is formed with holes 52 adjacent its ends and spaced to line up with tapped holes 50 in the base 23 straddling the receiving zone 42. Preferably, upper surfaces 53 on the holder 24 lie in a plane that includes the axis of the cylindrical surface 48. The bearing 49 has the form of a segment of a cylindrical shell and is formed of carbon for its self-lubricating and temperature resistant properties.

With the bearing 49 in the holder 24, the holder is removably held on the base 23 by two machine screws 54 assembled through the holes 52 in the flange 46 and threaded into the tapped holes 50 in the base 23.

On the operator's side of the conveyor 10, the bearing mounting unit 22 locates the roller shafts 13, 14. The illustrated mounting unit 22 is conveniently made as a ductile iron casting and mounted by machine screws on an angle 56 common to identical mounting units at each roller pair. The bearing mounting unit 28 has a bearing seat or pocket 57 to receive a bearing 48 that can be identical to the bearing 49 used at the chain side for supporting the lower roller shaft 13. The upper roller shaft 14 is horizontally constrained between sides 58 formed in a forked upper area of the mounting unit 22 and is vertically supported by the lower roller 11 or material being conveyed through the nip between the rollers 11 and 12.

The site of the chain side bearings is crowded owing to the presence of the chain 17, sprockets 16, and chain guides (not shown) making access to this area difficult. The invention greatly reduces the time and effort to remove the shaft bearings 49 compared to prior art constructions wherein the sprockets must first be removed and then cylindrical shell bearings have to be driven out of their housings in which they are often frozen.

At the chain side, a bearing 49 can be removed by simply removing the two machine screws or bolts 54 and dropping the holder 24 down away from the shaft 13 and then out from under the sprocket 16. The shaft 13 can be temporarily blocked up until a new bearing 49 is in place. A worn bearing is relatively easy to remove from the holder pocket formed by the cylindrical surface 48 and lip 47 even if it becomes frozen in this area because a relatively limited surface contact area between the bearing and holder and because the bearing is largely exposed rather than being encircled by the holder. A new bearing 49 can be installed in the holder 24 by simply dropping it in the pocket formed by the surface 48 and lip 47. Once it is set in the holder pocket, the new bearing 49 can be quickly installed on the bearing mounting base 23. This procedure is accomplished by locating the holder 24 beneath the shaft 13 and against the base 23 and then, if necessary, juggling it back and forth in the conveyor direction until a projecting part 61 of the holder inward of the flange 46 and proximate to the base 23 falls into the slot existing between the vertical guide surfaces 38. The projecting portion 61 of the holder 24 forward of the flange 46 is sized for a clearance fit between these vertical surfaces 38. Once this forward or lead end 61 of the holder 24 is even partially in the slot between the vertical surfaces 38, the holder is guided by these surfaces as it is raised into abutment between its upper surfaces 53 and the downwardly facing base stop surfaces 39. At this time with the holder 24 retained in place manually or with a simple prop, the machine screws 54 can be installed and the job of replacing the bearing 49 is complete. The foregoing steps can be easily performed where the sprocket 16 remains in place on the respective shaft 13. The bearing 49 is trapped against axial movement between the lip 47 and the base 23 and angularly against rotation by portions of the horizontal stop surfaces 39 at the top of the receiving zone 42. The bearing 49 at the operator side can be changed by slightly elevating the shaft 13 at this end, popping out the worn bearing and replacing it with a fresh bearing and then lowering the shaft. The bearing 49 at this operator side can be retained by a screw threaded into a hole 59 on the outside of a vertical face of the bearing mounting unit 22. While the illustrated bearings 49 are shown as half cylinders, i.e. subtending and arc of 180 or slightly less than 180 degrees, other bearing segment configurations are feasible. For example, the bearings 49 can be formed with an arc of 120 degrees or slightly less by appropriately configuring the bearing mounting units 21, 22 where they receive the bearings.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A bearing mount assembly for a powered roller conveyor of the type used in veneer dryers comprising a bearing mount base and a bearing holder, the base having a lower part with a vertical surface adapted to abut a cage angle and apertures for fastening it to a vertical face of the cage angle, an upper end of the base being in the shape of a yoke open at the top for locating the shaft of an upper roller, the bearing holder having a pocket for holding an arcuate section of a sleeve bearing, the base and holder having mating surfaces capable of locating the holder in a position where it supports the bearing in registry with the desired axis of rotation of the shaft of a lower roller.

2. An assembly as set forth in claim 1, wherein the holder is removably mounted on the base and can be dismounted from the base while the base remains secured to the cage angle.

3. An assembly as set forth in claim 2, wherein the base and holder are configured so the holder, carrying the bearing, and the base straddling a vertical plane aligned with and passing through the axis of the shaft can be positioned on the base by initialing locating it beneath the shaft and then raising it vertically, the base having guiding and stop surfaces that index the holder vertically and horizontally to a desired location.

4. An assembly as set forth in claim 3, wherein the base has surfaces that restrain a bearing segment from rotation about the axis of the shaft.

5. An assembly as set forth in claim 1, wherein said base and holder have provisions for bolts extending between said base and holder to secure the holder to the base.

6. An assembly as set forth in claim 5, wherein said bolts are disposed on opposite sides of a vertical plane passing through said shaft.

7. An assembly as set forth in claim 6, wherein said base has vertical guiding surfaces that serve to locate and guide said holder from a position beneath the shaft to an operational position.

8. In a conveyor of the type used in veneer dryers, a bearing mount assembly for locating the lower and upper shafts of a pair of powered rollers forming a nip, the assembly including a base and a bearing holder, the holder being removably fixed on the base, the base being bolted to a cage angle, the bearing holder being removable and replaceable on the base for replacing a worn sleeve bearing element without removing the base or without removing a sprocket on a shaft supported by the bearing element outboard of the assembly.

9. A conveyor as set forth in claim 8, wherein the base affords surfaces cooperating with the holder to prevent rotation and axial movement of a sleeve bearing element disposed in said holder.
